(19) United States
(12) Patent Application Publication
(10) Pub. No.: US 2020/0334630 A1
(43) Pub. Date: Oct. 22, 2020

(54) SYSTEMS AND METHODS FOR FACILITATING STORING, DELIVERING, AND TRACKING OF LUGGAGE

(71) Applicant: Darwinly Designing, LLC, Vienna, VA (US)

(72) Inventors: Nawar Al Issa, Vienna, VA (US); Adam Trent, Seattle, WA (US)

(21) Appl. No.: 16/853,282

(22) Filed: Apr. 20, 2020

Related U.S. Application Data
(60) Provisional application No. 62/835,913, filed on Apr. 18, 2019.

(51) Int. Cl. G06Q 10/08; G06Q 50/30; G06Q 10/10; G06Q 50/14; G06Q 10/02; G06Q 30/00; G06K 7/10; G06K 7/14; G06F 21/31

(52) U.S. Cl. CPC G06Q 10/0833; G06Q 10/087; G06Q 10/0838; G06Q 50/30; G06Q 10/109; G06F 21/31; G06Q 10/02; G06Q 30/0185; G06K 7/10366; G06K 7/10297; G06K 7/1417; G06Q 50/14

(57) ABSTRACT

Disclosed herein is a method for provisioning traveling facilities. Accordingly, the method may include receiving a user information from a user device, receiving a unique luggage identifier, analyzing the unique luggage identifier, processing a luggage information, receiving a luggage information, storing the luggage information on a blockchain, receiving a request, analyzing the request and a luggage handler location and a luggage carrier location, processing the request, transmitting the request, retrieving the luggage information, retrieving a user information, a luggage handler information, and a luggage carrier information, transmitting the luggage handler information, receiving a storing selection, transmitting the luggage information, transmitting the luggage carrier information, receiving a delivery selection, transmitting the luggage information, receiving at least one tracking information, and storing the luggage information, the user information, the luggage carrier information, the luggage handler information, the storing selection, the delivery selection, the tracking information, and a notification on a blockchain.

The current application claims a priority to the U.S. Provisional Patent application Ser. No. 62/835,913 filed on Apr. 18, 2019. The current application is filed on Apr. 20, 2020 while Apr. 18, 2020 was on a weekend.

### TECHNICAL FIELD

Generally, the present disclosure relates to the field of data processing. More specifically, the present disclosure relates to systems and methods for facilitating storing, delivering, and tracking of luggage.

### BACKGROUND

Many people have found traveling cumbersome and challenging. Typically, this is mainly associated with the luggage the travelers need to deal with. Transporting luggage from home or office to a transportation hub (e.g., an airport, a pier, a bus station, a train station, etc.), or vice versa, is frequently one of the most tedious and cumbersome aspects of traveling for both business and pleasure travelers. After carrying the luggage to, for example, an airport, the travelers with check-in luggage are often forced to wait in long lines to manually check their luggage with airline personnel. Due to the time constraints prescribed by airline companies, the check-in process often forces travelers to hurry through the airport to board their flights on time, adding to an already stressful travel experience.

Moreover, upon arrival at the destination airport, the travelers have to wait at the luggage carousels for their luggage while airline personnel unload arriving flights and transport luggage to carousels. In addition, some business travelers have to carry their luggage directly from the airport to a business meeting because they do not have sufficient time to check-in at their hotel, especially in case of airline delays and/or unavoidable scheduling. Further, if a pleasure traveler wants to go to entertaining attractions before or after the flight, she/he has to drag their luggage from place to place, creating serious inconvenience.

Therefore, there is a need for improved systems and methods for facilitating storing, delivering, and tracking of luggage that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating storing, delivering, and tracking of luggage, in accordance with some embodiments. Accordingly, the method may include a step of receiving, using a communication device, a user information from at least one user device. Further, the method may include a step of receiving, using the communication device, a unique luggage identifier associated with a luggage from the at least one user device. Further, the method may include a step of analyzing, using a processing device, the unique luggage identifier corresponding to a plurality of luggage. Further, the method may include a step of processing, using the processing device, at least one luggage information based on the analyzing of the user information and the unique luggage identifier. Further, the method may include a step of receiving, using the communication device, at least one luggage information associated with a unique luggage identifier from a handheld device. Further, the method may include a step of storing, using a storage device, the at least one luggage information associated with the unique luggage identifier on a blockchain. Further, the method may include a step of receiving, using the communication device, a request from at least one user device associated with a user. Further, the method may include a step of analyzing, using the processing device, the request and the at least one of a luggage handler location and a luggage carrier location. Further, the method may include a step of processing, using the processing device, the request based on the analyzing of the request and at least one of the luggage handler location and the luggage carrier location. Further, the method may include a step of transmitting, using the communication device, the request corresponding to a user of a plurality of users to at least one of a luggage handler device and a luggage carrier device. Further, the method may include a step of retrieving, using the storing device, the luggage information associated with the unique luggage identifier. Further, the method may include a step of retrieving, using the storage device, a user information associated with the plurality of users, a luggage handler information associated with a plurality of luggage handlers, and a luggage carrier information associated with a plurality of luggage carriers. Further, the method may include a step of transmitting, using the communication device, the luggage handler information corresponding to the plurality of luggage handlers to at least one of a luggage carrier device and the at least one user device. Further, the method may include a step of receiving, using the communication device, a storing selection corresponding to a luggage handler of the plurality of luggage handlers from the at least one user device. Further, the method may include a step of transmitting, using the communication device, the at least one luggage information to a luggage handler device associated with the luggage handler. Further, the method may include a step of transmitting, using the communication device, the luggage carrier information corresponding to the plurality of luggage carriers to at least one of a luggage handler device and the at least one user device. Further, the method may include a step of receiving, using the communication device, a delivery selection corresponding to a luggage carrier of the plurality of luggage carriers from the at least one user device. Further, the method may include a step of transmitting, using the communication device, the at least one luggage information to a luggage carrier device associated with the luggage carrier. Further, the method may include a step of receiving, using the communication device, at least one tracking information corresponding to the luggage from at least one of the luggage handler device, the luggage carrier device, and the at least one user device. Further, the method may include a step of storing, using the storage device, at least one of the at least one luggage information, the user information, the luggage carrier information, the luggage handler information, the storing selection, the delivery selection, the at least one tracking information, and a notification on a blockchain.

Further disclosed herein is a system for facilitating storing, delivering, and tracking of luggage, in accordance with some embodiments. Accordingly, the system may include a communication device, a processing device, and a storage device. Further, the communication device may be configured for receiving a user information from the at least one user device. Further, the communication device may be configured for receiving a unique luggage identifier associated with a luggage from the at least one user device. Further, the communication device may be configured for receiving at least one luggage information associated with a unique luggage identifier from a handheld device. Further, the communication device may be configured for receiving a request from at least one user device associated with a user. Further, the communication device may be configured for transmitting the request corresponding to a user of the plurality of users to at least one of a luggage handler device and a luggage carrier device. Further, the communication device may be configured for transmitting a luggage handler information corresponding to a plurality of luggage handlers to at least one of a luggage carrier device and the at least one user device. Further, the communication device may be configured for receiving a storing selection corresponding to a luggage handler of the plurality of luggage handlers from the at least one user device. Further, the communication device may be configured for transmitting the at least one luggage information to a luggage handler device associated with the luggage handler. Further, the communication device may be configured for transmitting a luggage carrier information corresponding to a plurality of luggage carriers to at least one of a luggage handler device and the at least one user device. Further, the communication device may be configured for receiving a delivery selection corresponding to a luggage carrier of the plurality of luggage carriers from the at least one user device. Further, the communication device may be configured for transmitting the at least one luggage information to a luggage carrier device associated with the luggage carrier. Further, the communication device may be configured for receiving at least one tracking information corresponding to the luggage from at least one of the luggage handler device, the luggage carrier device, and the at least one user device. Further, the processing device may be configured for analyzing the luggage identifier corresponding to a plurality of luggage. Further, the processing device may be configured for processing at least one luggage information based on the analyzing of the user information and the unique luggage identifier. Further, the processing device may be configured for analyzing the request and the at least one of the luggage handler location and the luggage carrier location. Further, the processing device may be configured for processing the request based on the analyzing of the request and the at least one of the luggage handler location and the luggage carrier location. Further, the storage device may be configured for storing at least one luggage information associated with a unique luggage identifier on a blockchain. Further, the storage device may be configured for retrieving the luggage information associated with the unique luggage identifier. Further, the storage device may be configured for retrieving the user information associated with the plurality of users, the luggage handler information associated with the plurality of luggage handlers, and the luggage carrier information associated with the plurality of luggage carriers. Further, the storage device may be configured for storing at least one of the at least one luggage information, the user information, the luggage carrier information, the luggage handler information, the storing selection, the delivery selection, and the at least one tracking information on a blockchain.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating storing, delivering, and tracking of luggage, in accordance with some embodiments.

FIG. 3 is a flowchart of a method for facilitating storing, delivering, and tracking of luggage, in accordance with some embodiments.

FIG. 4 is a continuation flowchart of the method for facilitating storing, delivering, and tracking of luggage, accordance with some embodiments.

FIG. 5 is a flowchart of a method for facilitating generation of a notification based on tracking information, in accordance with some embodiments.

FIG. 6 is a flowchart of a method for facilitating generation of a time schedule based on transportation data and luggage information, in accordance with some embodiments.

FIG. 7 is a flowchart of a method for facilitating generation of a service schedule, in accordance with some embodiments.

FIG. 8 is a flowchart of a method for facilitating generation of a user verification notification based on user information, luggage carrier information, and luggage information, in accordance with some embodiments.

FIG. 9 is a flowchart of a method for facilitating generation of a user verification notification based on user information, luggage handler information, and luggage information, in accordance with some embodiments.

FIG. 10 is a block diagram of a system showing an architecture of a luggage transportation platform, in accordance with some embodiments.

FIG. 11 is a flow diagram of a method for facilitating transporting of luggage, in accordance with some embodiments.

FIG. 12 is a flow diagram of a method for facilitating transporting of luggage to transportation hub personnel, in accordance with some embodiments.

FIG. 13 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems and methods for provisioning traveling facilities, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, a public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes systems and methods for facilitating storing, delivering, and tracking of luggage. Further, the present disclosure may be a luggage transportation platform that may operate on a mobile device or other electronic devices to help users deliver, store, and track the luggage. Further, the present disclosure may be a stand-alone application or may be incorporated into other applications of third-party service providers, e.g., ridesharing applications. Further, the present disclosure may also allow other applications to be included to provide a variety of additional services, such as ridesharing services, restaurant take-outs, event ticket services, etc.

Further, the luggage transportation platform may eliminate or significantly alleviate the inconvenience associated with the luggage carried by travelers from a first location to a second location and create a chain of custody to ensure the security of the luggage during transportation. Both the first and second locations may be specified by a user.

Further, the luggage transportation platform designed to offer a new method for delivering, storing, and tracking users' luggage. Further, the disclosed system may include a user management engine, an order management engine, a verification engine, a luggage tracking engine, a notification engine, an application programming interface (“API”) engine, and one or more databases. Further, the one or more databases may include a regular database and a blockchain database. further, the disclosed system may further include an identifier generating engine. Further, the term “engine” may be used to refer to collections of programs that are grouped based upon function.

Further, the present disclosure may provide a method to have the luggage picked up at a first location specified by a user and delivered to a second location also specified by the user. Further, the disclosed method may be in the form of a mobile application that may operate on a mobile device (such as a smartphone, a tablet, etc.) that possesses computing capability and network connectivity. However, preferably, some or all of the features of the present disclosure may be incorporated into other applications and/or websites provided by third parties via API or any other suitable technologies. Examples of the applications and/or websites of the third parties may include, but be not limited to ridesharing applications (e.g., Uber™, Lyft™, etc.), traveling agency applications/websites (e.g., Booking™, Expedia™, Priceline™, etc.), hotel and lodging applications/websites (e.g., Hotels.com, Airbnb, etc.), airlines applications/websites (e.g., Fly Delta, Spirit, Southwest Airlines, etc.), and the like.

Further, the present disclosure may employ an identifier to uniquely identify a piece of luggage. For instance, the identifier may be a unique luggage identification number. Further, the unique luggage identification number may be associated with a Quick Response (“QR”) Code, a barcode, a Radio Frequency (RF) identification tag, a Near-Field Communication (NFC) tag, etc. Preferably, the identifier can be scanned or detected by a handheld device (for example, a smartphone) which comprises a camera, an RF reader, and/or an NFC reader. Further, in some embodiments, the identifier may be a built-in identifier that is embedded during the manufacturing process. Further, the identifier may be generated and permanently attached to the luggage before it was sold. However, in some embodiments, the identifiers may also be generated by the identifier generating engine of the present disclosure and may be permanently or temporarily attached to users' existing luggage.

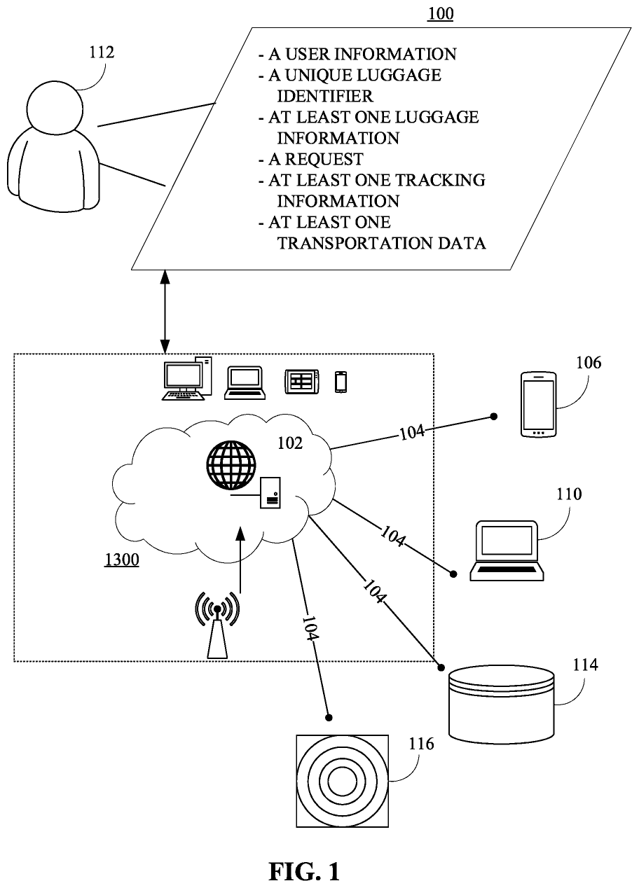

Referring now to figures, FIG. 1 is an illustration of an online platform 100 consistent with various embodiments of the present disclosure. By way of non-limiting example, the online platform 100 to facilitate storing, delivering, and tracking of luggage may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform 100.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1300.

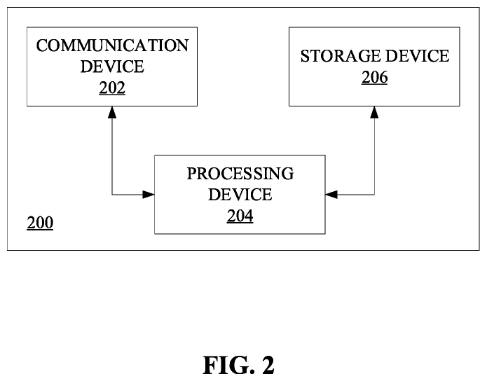

FIG. 2 is a block diagram of a system 200 for facilitating storing, delivering, and tracking of luggage, in accordance with some embodiments. Accordingly, the system 200 may include a communication device 202, a processing device 204, and a storage device 206.

Further, the communication device 202 may be configured for receiving a user information from the at least one user device. Further, the communication device 202 may be configured for receiving a unique luggage identifier associated with a luggage from the at least one user device. Further, the unique luggage identifier may be associated with at least one of a Quick Response (QR) code, a bar code, a Radio Frequency (RF) identification tag, and a Near Field Communication (NFC) tag. Further, the communication device 202 may be configured for receiving at least one luggage information associated with a unique luggage identifier from a handheld device. Further, at least one of the at least one user device, a luggage carrier device, a luggage handler device, and the handheld device may include at least one of a camera, an RF reader, and an NFC reader. Further, the communication device 202 may be configured for receiving a request from at least one user device associated with a user. Further, the request may include at least one of a user location, a luggage drop-off location, and a luggage pick-up location. Further, the communication device 202 may be configured for transmitting the request corresponding to a user of the plurality of users to at least one of a luggage handler device and a luggage carrier device. Further, the communication device 202 may be configured for transmitting a luggage handler information corresponding to a plurality of luggage handlers to at least one of a luggage carrier device and the at least one user device. Further, the communication device 202 may be configured for receiving a storing selection corresponding to a luggage handler of the plurality of luggage handlers from the at least one user device. Further, the communication device 202 may be configured for transmitting the at least one luggage information to a luggage handler device associated with the luggage handler. Further, the communication device 202 may be configured for transmitting a luggage carrier information corresponding to a plurality of luggage carriers to at least one of a luggage handler device and the at least one user device. Further, the communication device 202 may be configured for receiving a delivery selection corresponding to a luggage carrier of the plurality of luggage carriers from the at least one user device. Further, the communication device 202 may be configured for transmitting the at least one luggage information to a luggage carrier device associated with the luggage carrier. Further, the communication device 202 may be configured for receiving at least one tracking information corresponding to the luggage from at least one of the luggage handler device, the luggage carrier device, and the at least one user device.

Further, the processing device 204 may be configured for analyzing the luggage identifier corresponding to a plurality of luggage. Further, the processing device 204 may be configured for processing at least one luggage information based on the analyzing of the user information and the unique luggage identifier. Further, the processing device 204 may be configured for analyzing the request and the at least one of the luggage handler location and the luggage carrier location. Further, the processing device 204 may be configured for processing the request based on the analyzing of the request and the at least one of the luggage handler location and the luggage carrier location.

Further, the storage device 206 may be configured for storing at least one luggage information associated with a unique luggage identifier on a blockchain. Further, the storage device 206 may be configured for retrieving the luggage information associated with the unique luggage identifier. Further, the storage device 206 may be configured for retrieving the user information associated with the plurality of users, the luggage handler information associated with the plurality of luggage handlers, and the luggage carrier information associated with the plurality of luggage carriers. Further, the storage device 206 may be configured for storing at least one of the at least one luggage information, the user information, the luggage carrier information, the luggage handler information, the storing selection, the delivery selection, and the at least one tracking information on a blockchain.

Further, in some embodiments, the communication device 202 may be configured for transmitting a notification to at least one of the luggage handler device, the luggage carrier device, and the at least one user device. Further, the processing device 204 may be configured for analyzing the at least one tracking information. Further, the processing device 204 may be configured for generating the notification based on the analyzing of the at least one tracking information.

Further, in some embodiments, the communication device 202 may be configured for receiving at least one transportation data associated with the user from the at least one user device. Further, the communication device 202 may be configured for transmitting a time schedule to at least one of the at least one user device, the luggage handler device, and the luggage carrier device. Further, the communication device 202 may be configured for transmitting a time schedule notification to at least one of the at least one user device, the luggage handler device, and the luggage carrier device. Further, the processing device 204 may be configured for analyzing the at least one transportation data. Further, the processing device 204 may be configured for processing the at least one transportation data and the at least one luggage information. Further, the processing device 204 may be configured for generating the time schedule associated with the luggage based on the analyzing of at least one of the request, the at least one transportation data, and at least one luggage information. Further, the processing device 204 may be configured for generating the time schedule notification based on the analyzing of the time schedule. Further, the storage device 206 may be configured for storing the time schedule on the blockchain.

Further, in some embodiment, the communication device 202 may be configured for receiving a service request from the at least one user device. Further, the communication device 202 may be configured for transmitting a service menu corresponding to at least one service to the at least one user device. Further, the communication device 202 may be configured for receiving at least one service response corresponding to the at least one service. Further, the communication device 202 may be configured for transmitting a service schedule to at least one of the at least one user device, the luggage handler device, and the luggage carrier device. Further, the processing device 204 may be configured for analyzing the service request determining the at least one service based on the analyzing of the service request. Further, the processing device 204 may be configured for analyzing at least one of the at least one service response, the at least one transportation data, and the at least one luggage information. Further, the processing device 204 may be configured for generating the service schedule associated with the luggage corresponding to the at least one service based on the analyzing of at least one of the request, the at least one service response, the at least one transportation data, and the at least one luggage information. Further, the storage device 206 may be configured for storing the service schedule.

Further, in some embodiments, the communication device 202 may be configured for receiving a luggage carrier information from the luggage carrier device. Further, the communication device 202 may be configured for transmitting a user verification notification to the luggage carrier device. Further, the processing device 204 may be configured for analyzing the luggage carrier information, the user information, and the at least one luggage information. Further, the processing device 204 may be configured for generating the user verification notification based on the analyzing of the luggage carrier information, the user information, and the at least one luggage information. Further, the storage device 206 may be configured for storing the user verification notification on the blockchain.

Further, in some embodiments, the communication device 202 may be configured for receiving a luggage handler information from the luggage handler device. Further, the communication device 202 may be configured for transmitting a user verification notification to at least one of the luggage handler device. Further, the processing device 204 may be configured for analyzing the luggage handler information, the user information, and the at least one luggage information. Further, the processing device 204 may be configured for generating the user verification notification based on the analyzing of the luggage handler information, the user information, and the at least one luggage information. Further, the storage device 206 may be configured for storing the user verification notification on the blockchain.

Further, in an embodiment, the unique luggage identifier may include a built-in identifier. Further, the built-in identifier may be embedded on the luggage during the manufacturing process. Further, the built-in identifier may be generated and permanently attached to the luggage before selling the luggage.

Further, the communication device 202 may be configured for receiving a user information from the at least one user device. Further, the communication device 202 may be configured for receiving a request from at least one user device associated with a user. Further, the communication device 202 may be configured for transmitting the request corresponding to a user of the plurality of users to at least one of a luggage handler device and a luggage carrier device.

Further, the communication device 202 may be configured for receiving a unique luggage identification number associated with a luggage from a handheld device. Further, the unique luggage identification number may include the unique luggage identifier. Further, the communication device 202 may be configured for receiving at least one luggage information associated with the luggage from the at least one user device. Further, the communication device 202 may be configured for transmitting a luggage handler information corresponding to a plurality of luggage handlers to at least a luggage carrier device and the at least one user device. Further, the communication device 202 may be configured for receiving a storing selection corresponding to a luggage handler of the plurality of luggage handlers from the at least one user device. Further, the communication device 202 may be configured for transmitting the at least one luggage information to a luggage handler device associated with the luggage handler. Further, the communication device 202 may be configured for transmitting a luggage carrier information corresponding to a plurality of luggage carriers to at least a luggage handler device and the at least one user device. Further, the communication device 202 may be configured for receiving a delivery selection corresponding to a luggage carrier of the plurality of luggage carriers from the at least one user device. Further, the communication device 202 may be configured for transmitting the at least one luggage information to a luggage carrier device associated with the luggage carrier. Further, the communication device 202 may be configured for receiving at least one tracking information corresponding to the luggage from at least one of the luggage handler device, the luggage carrier device, and the at least one user device.

Further, the processing device 204 may be configured for analyzing the luggage identifier corresponding to a plurality of luggage; processing at least one luggage information based on the analyzing of the user information and the unique luggage identifier; analyzing the request and the at least one of the luggage handler location and the luggage carrier location; and processing the request based on the analyzing of the request and the at least one of the luggage handler location and the luggage carrier location.

Further, the storage device 206 may be configured for storing at least one luggage information associated with a unique luggage identifier on a blockchain; retrieving the luggage information associated with the unique luggage identifier; and retrieving the luggage handler information associated with the plurality of luggage handlers and the luggage carrier information associated with the plurality of luggage carriers. Further, the storage device 206 may be configured for storing at least one of the at least one luggage information, the luggage carrier information, the luggage handler information, the first selection, the second selection, and the at least one tracking information on a blockchain.

Further, in some embodiments, the communication device 202 may be configured for transmitting a notification to the at least one user device. Further, the processing device 204 may be configured for analyzing the at least one tracking information. Further, the processing device 204 may be configured for generating the notification based on the analyzing of the at least one tracking information.

Further, in some embodiments, the unique luggage identification number may include a Quick Response (QR) code, a bar code, a Radio Frequency (RF) identification tag, and a Near Field Communication (NFC) tag.

Further, in some embodiments, at least one of the at least one user device, the luggage carrier device, the luggage handler device, and the handheld device may include a camera, an RF reader, and an NFC reader.

Further, in some embodiments, the communication device 202 may be configured for receiving at least one airline data associated with the user from the at least one user device. Further, the at least one airline data may include the at least one transportation data. Further, the communication device 202 may be configured for transmitting a schedule to at least one of the at least one user device, the luggage handler device, and the luggage carrier device. Further, the processing device 204 may be configured for processing the at least one airline data and the at least one luggage information. Further, the processing device 204 may be configured for generating the schedule based on the processing of the at least one airline data and at least one luggage information. Further, the storage device 206 may be configured for storing the schedule on the blockchain.

Further, in some embodiments, the communication device 202 may be configured for receiving a service request from the at least one user device. Further, the communication device 202 may be configured for transmitting a service menu corresponding to at least one service to the at least one user device. Further, the communication device 202 may be configured for receiving at least one service response corresponding to the at least one service. Further, the at least one service response may include at least one parameter associated with the at least one service. Further, the at least one service response may include a pick up location and a destination location associated with the luggage. Further, the communication device 202 may be configured for transmitting a service schedule to at least one of the at least one user device, the luggage handler device, and the luggage carrier device. Further, the processing device 204 may be configured for analyzing the service request. Further, the processing device 204 may be configured for determining the at least one service based on the analyzing of the service request. Further, the processing device 204 may be configured for analyzing at least one of the at least one service response, the at least one airline data, and the at least one luggage information. Further, the processing device 204 may be configured for generating the service schedule associated with the luggage corresponding to the at least one service based on the analyzing of at least one of the at least one service response, the at least one airline data, and the at least one luggage information. Further, the storage device 206 may be configured for storing the service schedule on the blockchain.

Further, in some embodiments, the at least one service may include a food service, an event ticket booking service, traveling service, hotel service, and a ridesharing service.

Further, in some embodiments, the communication device 202 may be configured for receiving a luggage carrier information from the luggage carrier device. Further, the communication device 202 may be configured for transmitting a user verification notification to the luggage carrier device. Further, the processing device 204 may be configured for analyzing the user information, the luggage carrier information, and the at least one luggage information. Further, the processing device 204 may be configured for generating the user verification notification based on the analyzing of the user information, the luggage carrier information, and the at least one luggage information. Further, the storage device 206 configured for storing the user verification notification on the blockchain.

Further, in some embodiments, the communication device 202 may be configured for receiving a luggage handler information from the luggage handler device. Further, the communication device 202 may be configured for transmitting a user verification notification to the luggage handler device. Further, the processing device 204 may be configured for analyzing, using the processing device 204, the user information, the luggage handler information, and the at least one luggage information. Further, the processing device 204 may be configured for generating the user verification notification based on the analyzing of the user information, the luggage handler information, and the at least one luggage information. Further, the storage device 206 may be configured for storing the handler verification notification on the blockchain.

Further, in some embodiments, the unique luggage identification number may include a built-in identifier. Further, the built-in identifier may be embedded on the luggage during the manufacturing process. Further, the built-in identifier may be generated and permanently attached to the luggage before selling the luggage.

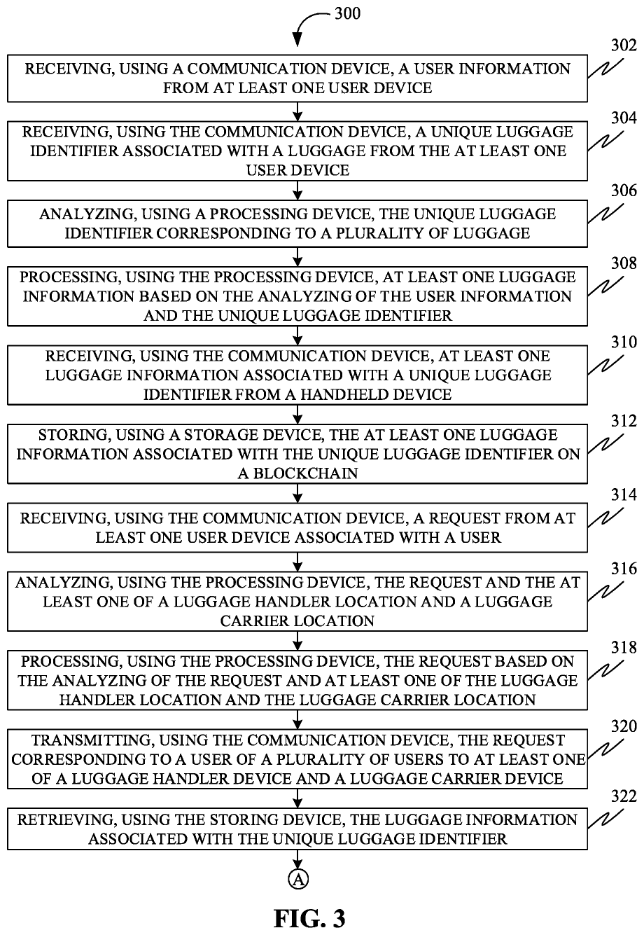

FIG. 3 is a flowchart of a method 300 for facilitating storing, delivering, and tracking of luggage, in accordance with some embodiments. Accordingly, at 302, the method 300 may include a step of receiving, using a communication device, a user information from at least one user device.

Further, at 304, the method 300 may include a step of receiving, using the communication device, a unique luggage identifier associated with a luggage from the at least one user device. Further, the unique luggage identifier may be associated with at least one of a Quick Response (QR) code, a bar code, a Radio Frequency (RF) identification tag, and a Near Field Communication (NFC) tag.

Further, at 306, the method 300 may include a step of analyzing, using a processing device, the unique luggage identifier corresponding to a plurality of luggage.

Further, at 308, the method 300 may include a step of processing, using the processing device, at least one luggage information based on the analyzing of the user information and the unique luggage identifier.

Further, at 310, the method 300 may include a step of receiving, using the communication device, at least one luggage information associated with a unique luggage identifier from a handheld device. Further, at least one of the at least one user device, a luggage carrier device, a luggage handler device, and the handheld device may include at least one of a camera, an RF reader, and an NFC reader.

Further, at 312, the method 300 may include a step of storing, using a storage device, the at least one luggage information associated with the unique luggage identifier on a blockchain.

Further, at 314, the method 300 may include a step of receiving, using the communication device, a request from at least one user device associated with a user. Further, the request may include at least one of a user location, a luggage drop-off location, and a luggage pick-up location.

Further, at 316, the method 300 may include a step of analyzing, using the processing device, the request and the at least one of a luggage handler location and a luggage carrier location.

Further, at 318, the method 300 may include a step of processing, using the processing device, the request based on the analyzing of the request and at least one of the luggage handler location and the luggage carrier location.

Further, at 320, the method 300 may include a step of transmitting, using the communication device, the request corresponding to a user of a plurality of users to at least one of a luggage handler device and a luggage carrier device.

Further, at 322, the method 300 may include a step of retrieving, using the storing device, the luggage information associated with the unique luggage identifier.

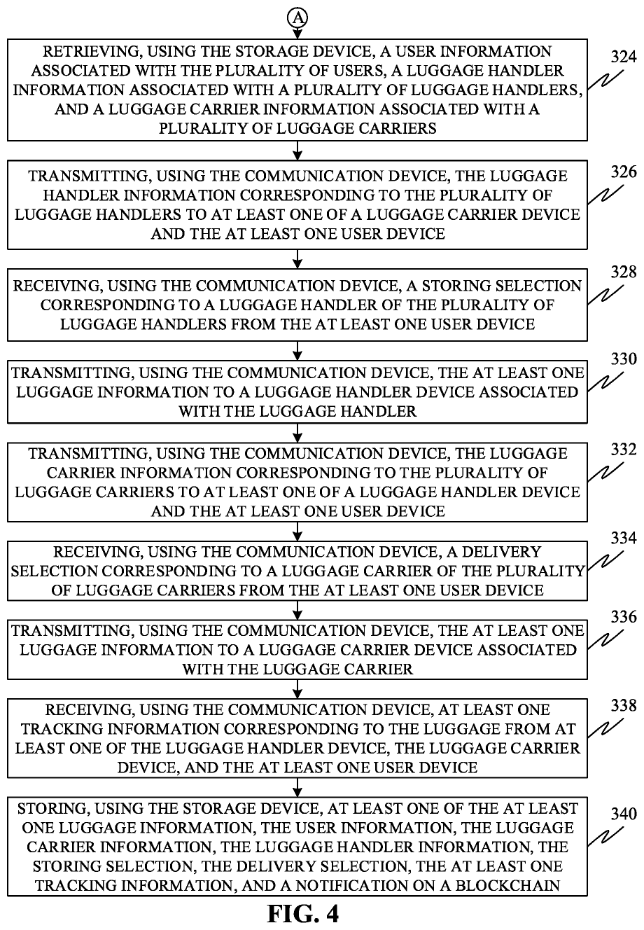

FIG. 4 is a continuation flowchart of the method 300 for facilitating storing, delivering, and tracking of luggage, accordance with some embodiments. Further, at 324, the method 300 may include a step of retrieving, using the storage device, a user information associated with the plurality of users, a luggage handler information associated with a plurality of luggage handlers, and a luggage carrier information associated with a plurality of luggage carriers.

Further, at 326, the method 300 may include a step of transmitting, using the communication device, the luggage handler information corresponding to the plurality of luggage handlers to at least one of a luggage carrier device and the at least one user device.

Further, at 328, the method 300 may include a step of receiving, using the communication device, a storing selection corresponding to a luggage handler of the plurality of luggage handlers from the at least one user device

Further, at 330, the method 300 may include a step of transmitting, using the communication device, the at least one luggage information to a luggage handler device associated with the luggage handler.

Further, at 332, the method 300 may include a step of transmitting, using the communication device, the luggage carrier information corresponding to the plurality of luggage carriers to at least one of a luggage handler device and the at least one user device.

Further, at 334, the method 300 may include a step of receiving, using the communication device, a delivery selection corresponding to a luggage carrier of the plurality of luggage carriers from the at least one user device.

Further, at 336, the method 300 may include a step of transmitting, using the communication device, the at least one luggage information to a luggage carrier device associated with the luggage carrier.

Further, at 338, the method 300 may include a step of receiving, using the communication device, at least one tracking information corresponding to the luggage from at least one of the luggage handler device, the luggage carrier device, and the at least one user device.

Further, at 340, the method 300 may include a step of storing, using the storage device, at least one of the at least one luggage information, the user information, the luggage carrier information, the luggage handler information, the storing selection, the delivery selection, the at least one tracking information, and a notification on a blockchain.

Further, in some embodiments, the method 300 may include a step of receiving, using a communication device, a request from at least one user device associated with a user. Further, the method 300 may include a step of analyzing, using a processing device, the request. Further, the method 300 may include a step of receiving, using the communication device, a unique luggage identification number associated with a luggage from a handheld device. Further, the method 300 may include a step of receiving, using the communication device, at least one luggage information associated with the luggage from the at least one user device. Further, the method 300 may include a step of retrieving, using a storage device, a luggage handler information associated with a plurality of luggage handlers and a luggage carrier information associated with a plurality of luggage carriers. Further, the method 300 may include a step of transmitting, using the communication device, the luggage handler information corresponding to the plurality of luggage handlers to the at least one user device. Further, the method 300 may include a step of receiving, using the communication device, a storing selection corresponding to a luggage handler of the plurality of luggage handlers from the at least one user device. Further, the method 300 may include a step of transmitting, using the communication device, the at least one luggage information to a luggage handler device associated with the luggage handler. Further, the method 300 may include a step of transmitting, using the communication device, the luggage carrier information corresponding to the plurality of luggage carriers to the at least one user device. Further, the method 300 may include a step of receiving, using the communication device, a delivery selection corresponding to a luggage carrier of the plurality of luggage carriers from the at least one user device. Further, the method 300 may include a step of transmitting, using the communication device, the at least one luggage information to a luggage carrier device associated with the luggage carrier. Further, the method 300 may include a step of receiving, using the communication device, at least one tracking information corresponding to the luggage from at least one of the luggage handler device, the luggage carrier device, and the at least one user device. Further, the method 300 may include a step of storing, using a storage device, at least one of the at least one luggage information, luggage carrier information, luggage handler information, the storing selection, the delivery selection, the at least one tracking information, and the notification on a blockchain.

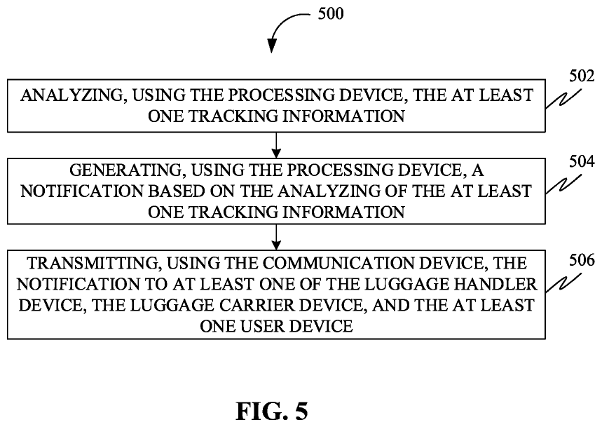

FIG. 5 is a flowchart of a method 500 for facilitating generation of a notification based on tracking information, in accordance with some embodiments. Accordingly, at 502, the method 500 may include a step of analyzing, using the processing device, the at least one tracking information.

Further, at 504, the method 500 may include a step of generating, using the processing device, a notification based on the analyzing of the at least one tracking information.

Further, at 506, the method 500 may include a step of transmitting, using the communication device, the notification to at least one of the luggage handler device, the luggage carrier device, and the at least one user device.

Further, in some embodiments, the method 500 may include a step of analyzing, using the processing device, the at least one tracking information. Further, the method 500 may include a step of generating, using the processing device, a notification based on the analyzing of the at least one tracking information. Further, the method 500 may include a step of transmitting, using the communication device, the notification to the at least one user device. Further, in some embodiments, the unique luggage identification number may include a Quick Response (QR) code, a bar code, a Radio Frequency (RF) identification tag, and a Near Field Communication (NFC) tag. Further, in some embodiments, at least one of the at least one user device, the luggage carrier device, the luggage handler device, and the handheld device may include a camera, an RF reader, and an NFC reader.

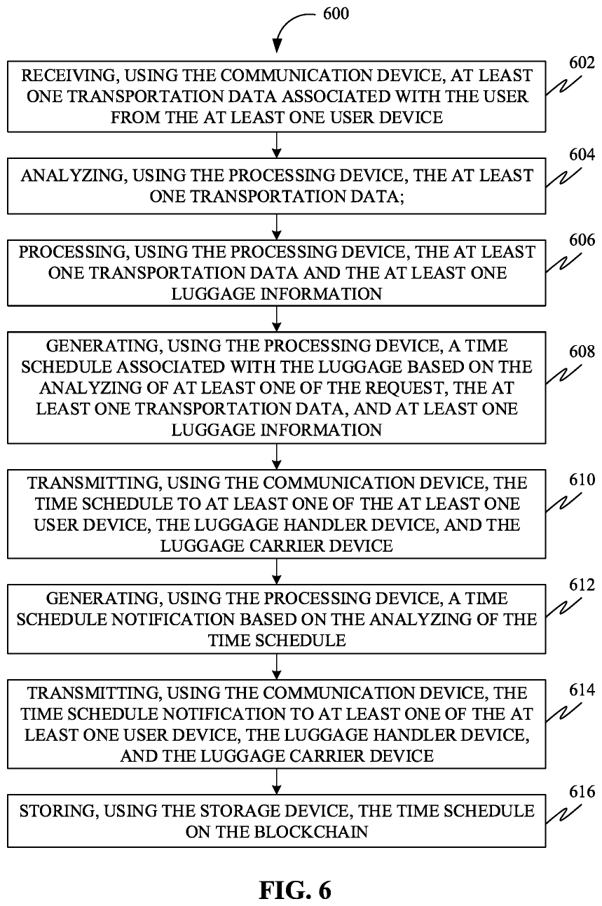

FIG. 6 is a flowchart of a method 600 for facilitating generation of a time schedule based on transportation data and luggage information, in accordance with some embodiments. Accordingly, at 602, the method 600 may include a step of receiving, using the communication device, at least one transportation data associated with the user from the at least one user device.

Further, at 604, the method 600 may include a step of analyzing, using the processing device, the at least one transportation data.

Further, at 606, the method 600 may include a step of processing, using the processing device, the at least one transportation data and the at least one luggage information.

Further, at 608, the method 600 may include a step of generating, using the processing device, a time schedule associated with the luggage based on the analyzing of at least one of the request, the at least one transportation data, and at least one luggage information.

Further, at 610, the method 600 may include a step of transmitting, using the communication device, the time schedule to at least one of the at least one user device, the luggage handler device, and the luggage carrier device.

Further, at 612, the method 600 may include a step of generating, using the processing device, a time schedule notification based on the analyzing of the time schedule.

Further, at 614, the method 600 may include a step of transmitting, using the communication device, the time schedule notification to at least one of the at least one user device, the luggage handler device, and the luggage carrier device.

Further, at 616, the method 600 may include a step of storing, using the storage device, the time schedule on the blockchain.

Further, in some embodiments, the method 600 may include a step of receiving, using the communication device, at least one airline data associated with the user from the at least one user device. Further, the method 600 may include a step of processing, using the processing device, the at least one airline data and the at least one luggage information. Further, the method 600 may include a step of generating, using the processing device, a schedule based on the processing of the at least one airline data and at least one luggage information. Further, the method 600 may include a step of transmitting, using the communication device, the schedule to at least one of the at least one user device, the luggage handler device, and the luggage carrier device. Further, the method 600 may include a step of storing, using the storage device, the schedule on the blockchain.

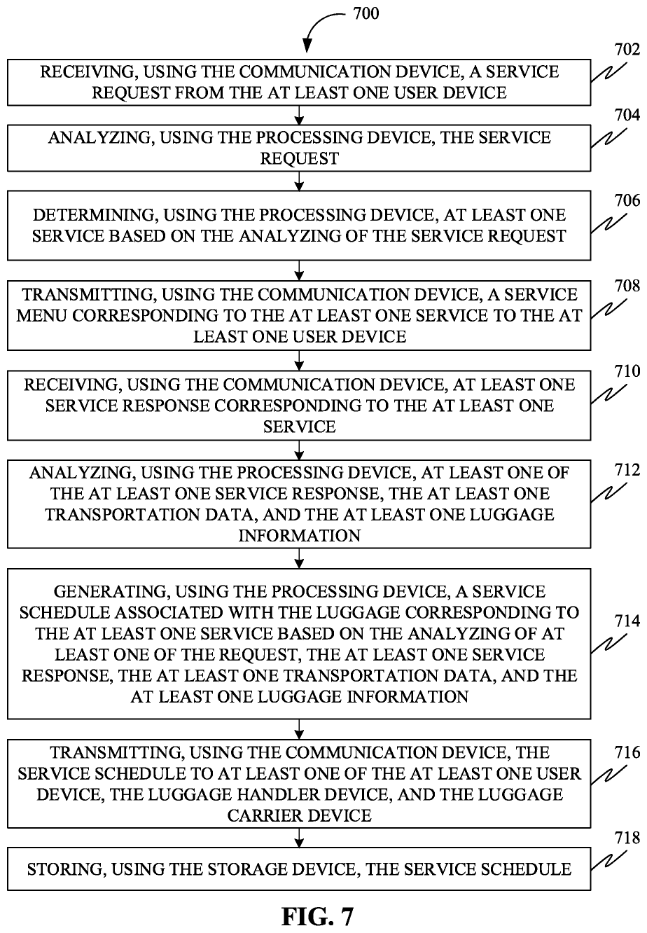

FIG. 7 is a flowchart of a method 700 for facilitating generation of a service schedule, in accordance with some embodiments. Accordingly, at 702, the method 700 may include a step of receiving, using the communication device, a service request from the at least one user device.

Further, at 704, the method 700 may include a step of analyzing, using the processing device, the service request.

Further, at 706, the method 700 may include a step of determining, using the processing device, at least one service based on the analyzing of the service request.

Further, at 708, the method 700 may include a step of transmitting, using the communication device, a service menu corresponding to the at least one service to the at least one user device.

Further, at 710, the method 700 may include a step of receiving, using the communication device, at least one service response corresponding to the at least one service. Further, the at least one service response may include at least one parameter associated with the at least one service. Further, the at least one service response may include a pick up location and a destination location associated with the luggage.

Further, at 712, the method 700 may include a step of analyzing, using the processing device, at least one of the at least one service response, the at least one transportation data, and the at least one luggage information.

Further, at 714, the method 700 may include a step of generating, using the processing device, a service schedule associated with the luggage corresponding to the at least one service based on the analyzing of at least one of the request, the at least one service response, the at least one transportation data, and the at least one luggage information.

Further, at 716, the method 700 may include a step of transmitting, using the communication device, the service schedule to at least one of the at least one user device, the luggage handler device, and the luggage carrier device.

Further, at 718, the method 700 may include a step of storing, using the storage device, the service schedule.

Further, in some embodiments, the at least one service may include a food service, an event ticket booking service, traveling service, hotel service, and a ridesharing service.

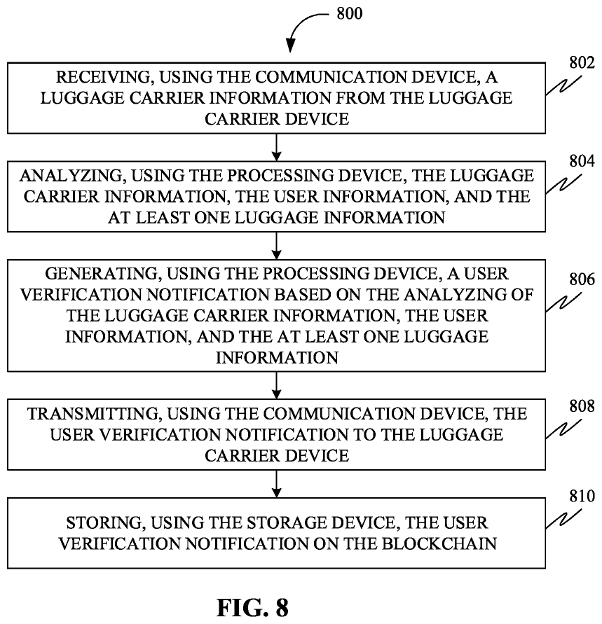

FIG. 8 is a flowchart of a method 800 for facilitating generation of a user verification notification based on user information, luggage carrier information, and luggage information, in accordance with some embodiments. Accordingly, at 802, the method 800 may include a step of receiving, using the communication device, a luggage carrier information from the luggage carrier device.

Further, at 804, the method 800 may include a step of analyzing, using the processing device, the luggage carrier information, the user information, and the at least one luggage information.

Further, at 806, the method 800 may include a step of generating, using the processing device, a user verification notification based on the analyzing of the luggage carrier information, the user information, and the at least one luggage information.

Further, at 808, the method 800 may include a step of transmitting, using the communication device, the user verification notification to the luggage carrier device.

Further, at 810, the method 800 may include a step of storing, using the storage device, the user verification notification on the blockchain.

Further, in some embodiments, the method 800 may include a step of receiving, using the communication device, a luggage carrier information from the luggage carrier device. Further, the method 800 may include a step of analyzing, using the processing device, the user information, the luggage carrier information, and the at least one luggage information. Further, the method 800 may include a step of generating, using the processing device, a user verification notification based on the analyzing of the user information, the luggage carrier information, and the at least one luggage information. Further, the method 800 may include a step of transmitting, using the communication device, the user verification notification to the luggage carrier device. Further, the method 800 may include a step of storing, using the storage device, the user verification notification on the blockchain.

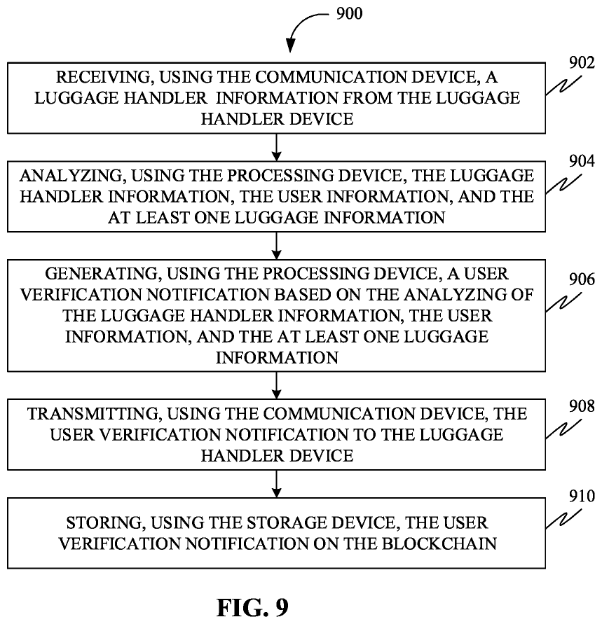

FIG. 9 is a flowchart of a method 900 for facilitating generation of a user verification notification based on user information, luggage handler information, and luggage information, in accordance with some embodiments. Accordingly, at 902, the method 900 may include a step of receiving, using the communication device, a luggage handler information from the luggage handler device.

Further, at 904, the method 900 may include a step of analyzing, using the processing device, the user information, the luggage handler information, and the at least one luggage information.

Further, at 906, the method 900 may include a step of generating, using the processing device, a user verification notification based on the analyzing of the user information, the luggage handler information, and the at least one luggage information.

Further, at 908, the method 900 may include a step of transmitting, using the communication device, the user verification notification to the luggage handler device.

Further, at 910, the method 900 may include a step of storing, using the storage device, the user verification notification on the blockchain.

Further, in some embodiments, the unique luggage identifier may include a built-in identifier. Further, the built-in identifier may be embedded on the luggage during the manufacturing process. Further, the built-in identifier may be generated and permanently attached to the luggage before selling the luggage.

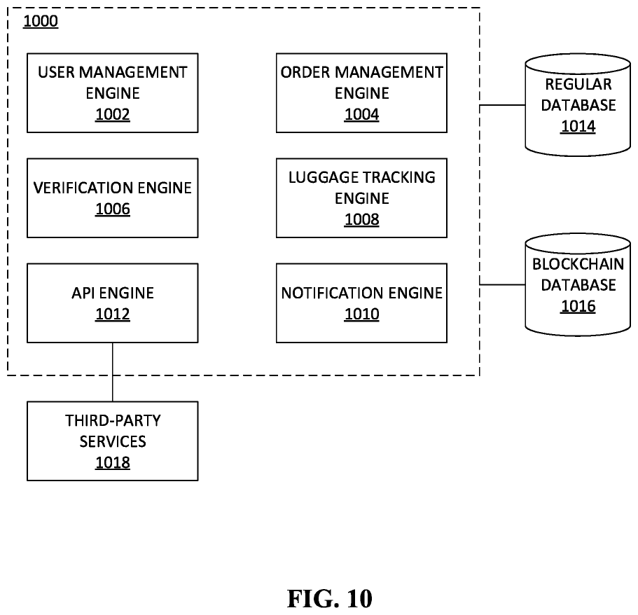

FIG. 10 is a block diagram of a system 1000 showing an architecture of a luggage transportation platform, in accordance with some embodiments. Accordingly, the system 1000 may include a user management engine 1002, an order management engine 1004, a verification engine 1006, a luggage tracking engine 1008, a notification engine 1010, and an application programming interface (API) engine 1012.

Further, the user management engine 1002 may be used to register users in a platform and perform authentication of users. Further, the users may need to provide registration information to create an account on the platform. Further, the user management engine 1002 may receive each user's registration information and creates accounts accordingly. For example, the user's registration information may include but is not limited to a username, a password, a phone number, payment information, etc. If the user already has an identifier associated with a piece of luggage, the identifier information (e.g., the luggage identification number) may be provided as part of the registration information. Further, the user management engine 1002 may generate login credentials for the user based on the user's registration information. In this way, each user may be able to access the luggage transportation platform using the login credentials from their smartphones, laptops, desktops, etc. Further, the registration information, together with the login credentials may be stored in a regular database 1014. Further, the system 1000 may also employ other authentication schemes, including but not limited to graphical password, pattern lock, and biometrics. Further, in some embodiment, the users may register and sign in using their existing ridesharing accounts or social media accounts.

Further, the order management engine 1004 may allow a user to place an order to have their luggage picked up at a user-specified first location and delivered to a user-specified second location. Further, the luggage delivery may be carried out by a luggage carrier. Further, the luggage carrier may be any entity that may deliver the luggage from one location to another. As an example, the luggage carrier may be a ridesharing driver, and the system 1000 may be incorporated into the ridesharing app. Further, in some embodiment, the order management engine 1004 may enable the user to schedule a date, time and location (for example, home or office) for the luggage carrier to pick up the luggage. However, under some circumstances, the user may be not available for the pick-up. Instead of waiting for the pick-up, the user may hand the luggage over to a luggage handler. Further, the luggage handler may be any entity that may have the ability to store the luggage. For example, the luggage handler may be the luggage storage service at a hotel, an airport, etc. Further, the luggage may be stored at the luggage handler before the luggage carrier comes to pick it up. Further, the second location may be the location of a luggage handler such that the delivered luggage can be stored at the luggage handler before the user placing the order comes to pick it up. Further, the second location may be a transportation hub (for example an airport), preferably, the check-in time of the airline may be monitored by the order management, and luggage handler or luggage carrier may hand over the luggage to airline personnel during the check-in time for security checks and loading. In this way, users do not need to deal with the luggage at the airport.

Further, the verification engine 1006 may be configured to verify if the current status of the luggage matches the information stored in blockchain database 1016. Further, in some embodiments, every time a previous entity hands the luggage over to a subsequent entity, the subsequent entity needs to scan the identifier so as to acquire information about the 15 luggage associated with the identifier. Such information may include the owner of the luggage (i.e., the user), the identity of the previous entity in possession of the luggage, the source location, the destination location, etc. Further, in some embodiments, the verification engine 1006 may use the information to verify if the entity handing over the luggage is identical to that stored in the blockchain database 1016. For example, when a luggage carrier (e.g., a ridesharing driver) goes to a location specified (e.g., the home of the user) by a user for a pick-up, the luggage carrier needs to scan the identifier to confirm the user's entity using the ridesharing app or the app provided by the present disclosure. Then the information about the luggage associated with the identifier is obtained. Further, the verification engine 1006 may allow the ridesharing driver to verify if the person handing over the luggage is the user. If the verification passes, the luggage tracking engine 1008 may record the location information of the luggage and the entity (i.e., the ridesharing driver) delivering the luggage into the blockchain database 1016, and the driver can start transporting the luggage to the destination location. If the verification fails, the verification engine 1006 instructs the notification engine 1010 to send an alert, together with the geographical location of the luggage, to notify the user of the abnormal condition. Further, the verification engine 1006 may halt the delivery process.

Further, the luggage tracking engine 1008 may enable users to get access to the status of the luggage. For example, a user may access the blockchain database 1016 via the luggage tracking engine 1008 and ascertain the location the luggage, the entity in possession of the luggage, the time the luggage was picked up, the time the luggage was handed over to a luggage carrier, an estimated time of delivery, etc. Further, in some embodiments, whenever the identifier may be scanned by a handheld device with a Global Positioning System (“GPS”) tracking unit, the blockchain database 1016 may be automatically updated with the geographical location obtained through the GPS tracking unit. Other information, including but not limited to the identity of the previous entity, the identity of the current entity in possession of the luggage, etc. may also be updated. As mentioned above, the tracking- and verification-related information may be stored in the blockchain database 1016 to create a chain of custody such that it may be impossible to tamper with the stored information. Further, in some embodiments, the luggage tracking engine 1008 further generates a map route of the luggage such that the location of the luggage is visualized. After the user finally picks up the luggage, she/he can scan the identifier to confirm receipt of the luggage.

Further, the notification engine 1010 may be configured to access the regular database 1014 and the blockchain database 1016 and generate notifications indicating the updates of the luggage delivery. For example, the user may be notified of the completion of the delivery, together with the location and arrival time of the luggage. Further, the notification may also send an alert to the user such that the user becomes aware of the abnormal condition.

Further, the API engine 1012 may be configured to provide a variety of additional services. For example, a user can have food delivered to a location specified by the user via third party services 1018; the user may also get access to tickets service to buy tickets for local events occurring near the destination location. In addition, the ridesharing services may also be provided through the API engine 1012.

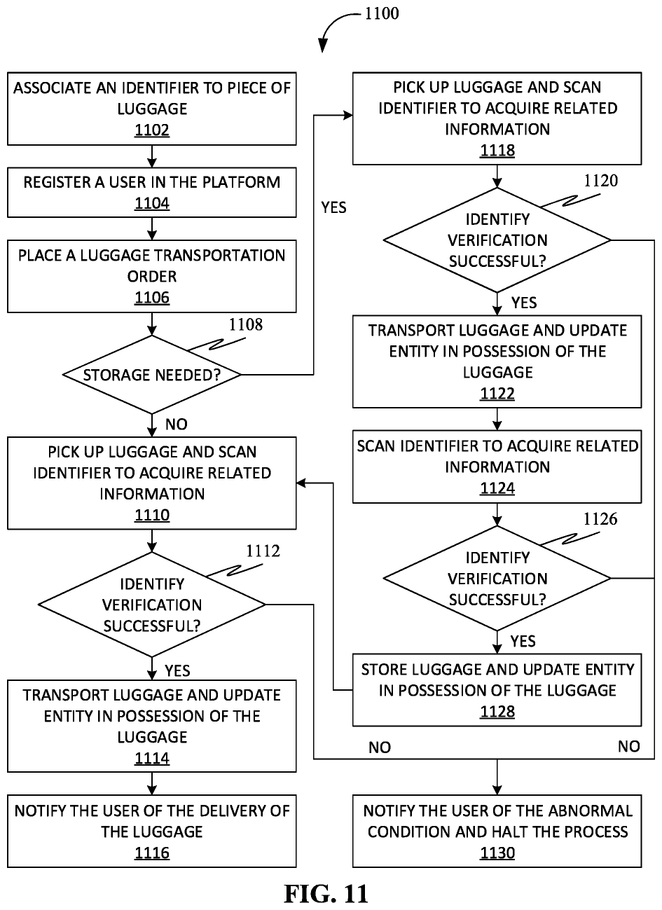

FIG. 11 is a flow diagram of a method 1100 for facilitating transporting of luggage, in accordance with some embodiments. Accordingly, at 1102, the method 1100 may include a step of associating an identifier to a piece of luggage. Further, at 1104, the method 1100 may include a step of registering a user in a platform. Further, at 1106, the method 1100 may include a step of placing a luggage transportation order. Further, at 1108 the method 1100 may include a step of determining whether storage of the luggage is needed or not. Further, if the storage of the luggage is not needed, then at 1110 the method 1100 may include a step of picking up the luggage and scanning the identifier to acquire related information. Further, at 1112, the method 1100 may include a step of determining whether verification of identity of the luggage is successful or not. Further, if the verification of the identity of the luggage is successful, then at 1114, the method 1100 may include a step of transporting the luggage and updating entity in possession of the luggage. Further, at 1116, the method 1100 may include a step of notifying the user of the delivery of the luggage. Further, if the storage of the luggage is needed, then at 1118, the method 1100 may include a step of picking up the luggage and scanning the identifier to acquire related information. Further, at 1120, the method 1100 may include a step of determining whether verification of the identity is successful or not. Further, if the verification of the identity is successful, then at 1122, the method 1100 may include a step of transporting the luggage and updating entity in possession of the luggage. Further, at 1124, the method 1100 may include a step of scanning the identifier to acquire related information. Further, at 1126, the method 1100 may include a step of determining whether verification of the identity is successful or not. Further, if the verification of the identity is successful, then at 1128, the method 1100 may include a step of storing the luggage and updating the entity in possession of the luggage. Further, if the verification of the identity is not successful, then at 1130, the method 1100 may include a step of notifying the user of the abnormal condition and halting the process of transporting the luggage.

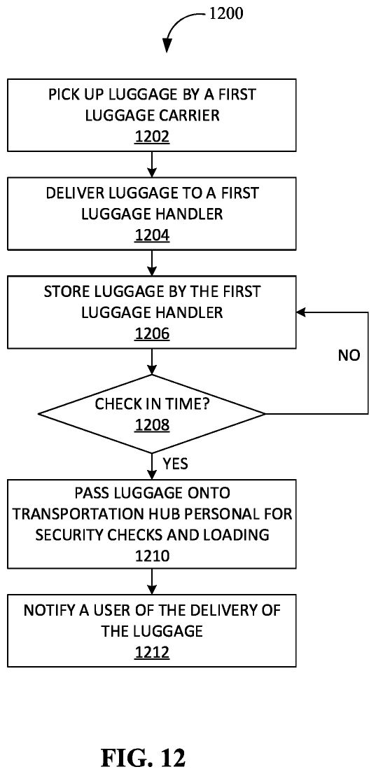

FIG. 12 is a flow diagram of a method 1200 for facilitating transporting of luggage to transportation hub personnel, in accordance with some embodiments. Accordingly, at 1202, the method 1200 may include a step of picking up luggage by a first luggage carrier. Further, at 1204, the method 1200 may include a step of delivering the luggage to a first luggage handler. Further, at 1206, the method 1200 may include a step of storing the luggage by the first luggage handler. Further, at 1208, the method 1200 may include a step of determining the check-in time of the user's luggage. Further, if the check-in of the user's luggage is not received, then at 1206, the method 1200 may include a step of storing the luggage by the first luggage handler. Further, if the check-in the user's luggage is received, then at 1210, the method 1200 may include a step of passing the luggage onto transportation hub personnel for security checks and loading. Further, at 1212, the method 1200 may include a step of notifying the user of the delivery of the luggage.

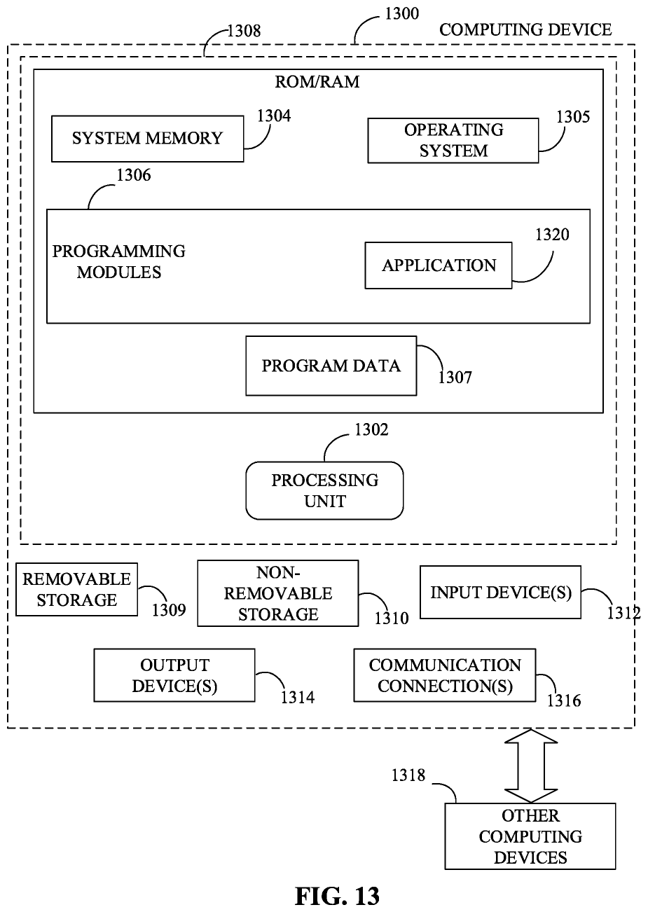

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random-access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include the image-processing module, machine learning module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, the computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and non-volatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1304, including operating system 1305. While executing on processing unit 1302, programming modules 1306 (e.g., application 1320 such as a media player) may perform processes including, for example, one or more stages of methods, algorithms, systems, applications, servers, databases as described above. The aforementioned process is an example, and processing unit 1302 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method for facilitating storing, delivering, and tracking of luggage, the method comprising:
receiving, using a communication device, a user information from at least one user device;
receiving, using the communication device, a unique luggage identifier associated with a luggage from the at least one user device, wherein the unique luggage identifier is associated with at least one of a Quick Response (QR) code, a bar code, a Radio Frequency (RF) identification tag, and a Near Field Communication (NFC) tag;
analyzing, using a processing device, the unique luggage identifier corresponding to a plurality of luggage;
processing, using the processing device, at least one luggage information based on the analyzing of the user information and the unique luggage identifier;
receiving, using the communication device, at least one luggage information associated with a unique luggage identifier from a handheld device, wherein at least one of the at least one user device, a luggage carrier device, a luggage handler device, and the handheld device comprises at least one of a camera, an RF reader, and an NFC reader;
storing, using a storage device, the at least one luggage information associated with the unique luggage identifier on a blockchain;
receiving, using the communication device, a request from at least one user device associated with a user, wherein the request comprises at least one of a user location, a luggage drop-off location, and a luggage pick-up location;
analyzing, using the processing device, the request and the at least one of a luggage handler location and a luggage carrier location;
processing, using the processing device, the request based on the analyzing of the request and at least one of the luggage handler location and the luggage carrier location;
transmitting, using the communication device, the request corresponding to a user of a plurality of users to at least one of a luggage handler device and a luggage carrier device;
retrieving, using the storing device, the luggage information associated with the unique luggage identifier;
retrieving, using the storage device, a user information associated with the plurality of users, a luggage handler information associated with a plurality of luggage handlers, and a luggage carrier information associated with a plurality of luggage carriers;
transmitting, using the communication device, the luggage handler information corresponding to the plurality of luggage handlers to at least one of a luggage carrier device and the at least one user device;
receiving, using the communication device, a storing selection corresponding to a luggage handler of the plurality of luggage handlers from the at least one user device;
transmitting, using the communication device, the at least one luggage information to a luggage handler device associated with the luggage handler;
transmitting, using the communication device, the luggage carrier information corresponding to the plurality of luggage carriers to at least one of a luggage handler device and the at least one user device;
receiving, using the communication device, a delivery selection corresponding to a luggage carrier of the plurality of luggage carriers from the at least one user device;
transmitting, using the communication device, the at least one luggage information to a luggage carrier device associated with the luggage carrier;
receiving, using the communication device, at least one tracking information corresponding to the luggage from at least one of the luggage handler device, the luggage carrier device, and the at least one user device; and
storing, using the storage device, at least one of the at least one luggage information, the user information, the luggage carrier information, the luggage handler information, the storing selection, the delivery selection, the at least one tracking information, and a notification on a blockchain.

2. The method of claim 1 further comprising:
analyzing, using the processing device, the at least one tracking information;
generating, using the processing device, a notification based on the analyzing of the at least one tracking information; and
transmitting, using the communication device, the notification to at least one of the luggage handler device, the luggage carrier device, and the at least one user device;

3. The method of claim 1 further comprising:
receiving, using the communication device, at least one transportation data associated with the user from the at least one user device;
analyzing, using the processing device, the at least one transportation data;
processing, using the processing device, the at least one transportation data and the at least one luggage information;
generating, using the processing device, a time schedule associated with the luggage based on the analyzing of at least one of the request, the at least one transportation data, and at least one luggage information;
transmitting, using the communication device, the time schedule to at least one of the at least one user device, the luggage handler device, and the luggage carrier device;
generating, using the processing device, a time schedule notification based on the analyzing of the time schedule;
transmitting, using the communication device, the time schedule notification to at least one of the at least one user device, the luggage handler device, and the luggage carrier device; and
storing, using the storage device, the time schedule on the blockchain.

4. The method of claim 3 further comprising:
receiving, using the communication device, a service request from the at least one user device;
analyzing, using the processing device, the service request;
determining, using the processing device, at least one service based on the analyzing of the service request;
transmitting, using the communication device, a service menu corresponding to the at least one service to the at least one user device;
receiving, using the communication device, at least one service response corresponding to the at least one service;
analyzing, using the processing device, at least one of the at least one service response, the at least one transportation data, and the at least one luggage information;
generating, using the processing device, a service schedule associated with the luggage corresponding to the at least one service based on the analyzing of at least one of the request, the at least one service response, the at least one transportation data, and the at least one luggage information;
transmitting, using the communication device, the service schedule to at least one of the at least one user device, the luggage handler device, and the luggage carrier device; and
storing, using the storage device, the service schedule.

5. The method of claim 4, wherein the at least one service comprises a food service, an event ticket booking service, traveling service, hotel service, and a ridesharing service.

6. The method of claim 1 further comprising:
receiving, using the communication device, a luggage carrier information from the luggage carrier device;
analyzing, using the processing device, the luggage carrier information, the user information, and the at least one luggage information;
generating, using the processing device, a user verification notification based on the analyzing of the luggage carrier information, the user information, and the at least one luggage information;
transmitting, using the communication device, the user verification notification to the luggage carrier device; and
storing, using the storage device, the user verification notification on the blockchain.

7. The method of claim 1 further comprising:
receiving, using the communication device, a luggage handler information from the luggage handler device;
analyzing, using the processing device, the luggage handler information, the user information, and the at least one luggage information;
generating, using the processing device, a user verification notification based on the analyzing of the luggage handler information, the user information, and the at least one luggage information;
transmitting, using the communication device, the user verification notification to the luggage handler device; and
storing, using the storage device, the user verification notification on the blockchain.

8. The method of claim 1, wherein the unique luggage identifier comprises a built-in identifier, wherein the built-in identifier is embedded on the luggage during the manufacturing process, wherein the built-in identifier is generated and permanently attached to the luggage before selling the luggage.

9. A system for facilitating storing, delivering, and tracking of luggage, the system comprising:
a communication device configured for:
receiving a user information from the at least one user device;
receiving a unique luggage identifier associated with a luggage from the at least one user device, wherein the unique luggage identifier is associated with at least one of a Quick Response (QR) code, a bar code, a Radio Frequency (RF) identification tag, and a Near Field Communication (NFC) tag;
receiving at least one luggage information associated with a unique luggage identifier from a handheld device, wherein at least one of the at least one user device, a luggage carrier device, a luggage handler device, and the handheld device comprises at least one of a camera, an RF reader, and an NFC reader;
receiving a request from at least one user device associated with a user, wherein the request comprises at least one of a user location, a luggage drop-off location, and a luggage pick-up location;
transmitting the request corresponding to a user of the plurality of users to at least one of a luggage handler device and a luggage carrier device;
transmitting a luggage handler information corresponding to a plurality of luggage handlers to at least one of a luggage carrier device and the at least one user device;
receiving a storing selection corresponding to a luggage handler of the plurality of luggage handlers from the at least one user device;
transmitting the at least one luggage information to a luggage handler device associated with the luggage handler;
transmitting a luggage carrier information corresponding to a plurality of luggage carriers to at least one of a luggage handler device and the at least one user device;
receiving a delivery selection corresponding to a luggage carrier of the plurality of luggage carriers from the at least one user device;
transmitting the at least one luggage information to a luggage carrier device associated with the luggage carrier; and
receiving at least one tracking information corresponding to the luggage from at least one of the luggage handler device, the luggage carrier device, and the at least one user device;
a processing device configured for:
analyzing the luggage identifier corresponding to a plurality of luggage;
processing at least one luggage information based on the analyzing of the user information and the unique luggage identifier;
analyzing the request and the at least one of the luggage handler location and the luggage carrier location; and
processing the request based on the analyzing of the request and the at least one of the luggage handler location and the luggage carrier location; and
a storage device configured for:
storing at least one luggage information associated with a unique luggage identifier on a blockchain;
retrieving the luggage information associated with the unique luggage identifier;
retrieving the user information associated with the plurality of users, the luggage handler information associated with the plurality of luggage handlers, and the luggage carrier information associated with the plurality of luggage carriers; and
storing at least one of the at least one luggage information, the user information, the luggage carrier information, the luggage handler information, the storing selection, the delivery selection, and the at least one tracking information on a blockchain.

10. The system of claim 9 further comprising:
the communication device configured for transmitting a notification to at least one of the luggage handler device, the luggage carrier device, and the at least one user device; and
the processing device configured for:
analyzing the at least one tracking information; and
generating the notification based on the analyzing of the at least one tracking information.

11. The system of claim 9 further comprising:
the communication device configured for:
receiving at least one transportation data associated with the user from the at least one user device;
transmitting a time schedule to at least one of the at least one user device, the luggage handler device, and the luggage carrier device; and
transmitting a time schedule notification to at least one of the at least one user device, the luggage handler device, and the luggage carrier device;
the processing device configured for:
analyzing the at least one transportation data;
processing the at least one transportation data and the at least one luggage information;
generating the time schedule associated with the luggage based on the analyzing of at least one of the request, the at least one transportation data, and at least one luggage information; and
generating the time schedule notification based on the analyzing of the time schedule; and
the storage device configured for storing the time schedule on the blockchain.

12. The system of claim 11 further comprising:
the communication device configured for:
receiving a service request from the at least one user device;
transmitting a service menu corresponding to at least one service to the at least one user device;
receiving at least one service response corresponding to the at least one service; and
transmitting a service schedule to at least one of the at least one user device, the luggage handler device, and the luggage carrier device;
the processing device configured for:
analyzing the service request;
determining the at least one service based on the analyzing of the service request;
analyzing at least one of the at least one service response, the at least one transportation data, and the at least one luggage information; and
generating the service schedule associated with the luggage corresponding to the at least one service based on the analyzing of at least one of the request, the at least one service response, the at least one transportation data, and the at least one luggage information; and
the storage device configured for storing the service schedule.

13. The system of claim 12, wherein the at least one service comprises a food service, an event ticket booking service, traveling service, hotel service, and a ridesharing service.

14. The system of claim 9 further comprising:
the communication device configured for:
receiving a luggage carrier information from the luggage carrier device; and
transmitting a user verification notification to the luggage carrier device;
the processing device configured for:
analyzing the luggage carrier information, the user information, and the at least one luggage information; and
generating the user verification notification based on the analyzing of the luggage carrier information, the user information, and the at least one luggage information; and
the storage device configured for storing the user verification notification on the blockchain.

15. The system of claim 9 further comprising:
the communication device configured for:
receiving a luggage handler information from the luggage handler device; and
transmitting a user verification notification to at least one of the luggage handler device;
the processing device configured for:
analyzing the luggage handler information, the user information, and the at least one luggage information; and
generating the user verification notification based on the analyzing of the luggage handler information, the user information, and the at least one luggage information; and
the storage device configured for storing the user verification notification on the blockchain.

16. The system of claim 9, wherein the unique luggage identifier comprises a built-in identifier, wherein the built-in identifier is embedded on the luggage during the manufacturing process, wherein the built-in identifier is generated and permanently attached to the luggage before selling the luggage.
